(19) United States
(12) Patent Application Publication
(10) Pub. No.: US 2026/0097797 A1
(43) Pub. Date: Apr. 9, 2026

(54) POSITIONING METHOD CAPABLE OF FUSING HISTORICAL OPERATION TRACK AND BEIDOU NAVIGATION, AND APPARATUS THEREOF

(71) Applicant: CASCO SIGNAL LTD., Shanghai (CN)

(72) Inventors: Jinyu YUE, Shanghai (CN); Geer HAN, Shanghai (CN); Qingwen JIA, Shanghai (CN); Yina LUO, Shanghai (CN); Jiajia CHENG, Shanghai (CN)

(21) Appl. No.: 19/114,345

(22) PCT Filed: Nov. 27, 2023
(86) PCT No.: PCT/CN2023/134396

§ 371 Date: Mar. 21, 2025

(30) Foreign Application Priority Data
Dec. 21, 2022 (CN) 202211651157.1

(51) Int. Cl. B61L 25/02; B61L 25/06; G01S 19/42

(52) U.S. Cl. CPC B61L 25/025; B61L 25/06; G01S 19/42

(57) ABSTRACT

Disclosed in the present invention are a positioning method capable of fusing a historical operation track and Beidou navigation, and an apparatus thereof. The method includes: receiving longitude and latitude information sent by a Beidou navigation system; determining validity of historical track information in combination with received longitude and latitude information and corresponding historical track information; when the historical track information is valid, searching an alternative section according to types of a terminal; traversing the alternative section, and converting longitude and latitude to section position information; according to the types of the terminal, determining whether converted section position information in the alternative section is valid; and when the converted section position information is valid, outputting the section position information. The present invention has the following advantages: according to the method, calculation is performed by fully utilizing the historical track information of the terminal, so that the calculation amount of a processor device is greatly reduced, and the compression rate can reach 98% or more; meanwhile, the CPU utilization rate is also increased; and a server with the same configuration can perform calculation tasks of larger stations, more stations and more terminals, so that the hardware input cost is saved.

### TECHNICAL FIELD

The present invention relates to the field of rail traffic, and in particular to a positioning method capable of fusing a historical operation track and Beidou navigation, and an apparatus thereof.

### BACKGROUND

In train positioning calculation of an early warning and protection system, positioning calculation is performed based on longitudinal and latitude information of a Beidou navigation system. In the calculation, locomotive and handheld terminal positioning modules read an electronic map of all stations; the electronic map includes station yard and station shape information, section information, and longitude and latitude information of all key points; after receiving longitude and latitude information transmitted by Beidou satellite, the positioning modules determine which station the point belongs to, then scan and calculate all sections of this station, and finally calculate the section where a locomotive head or a constructor is located and an offset of this section; and the section position information is sent to an early warning and protection server, and the early warning and protection server performs early warning calculation according to the section position information. This calculation method has two problems: 1. it is necessary to perform traversing calculation on all stations in the calculation process of the own station; and 2. it is necessary to perform traversing calculation on all section elements in the station in the section position conversion process. Since vector calculation is required in the calculation process, this involves two calculations of multiplication and division of a double data type; the two calculations (particularly the division calculation) particularly consume CPU calculation resources; for the two traversing calculations, the calculation amount is acceptable under the condition that the number of the stations, the number of the station sections and the number of the terminal are small, but the calculation amount will be explosively expanded under the condition that the number of the stations, the number of the station sections and the number of the terminal are increased sharply, for example, when there are 30 stations, each station has 200 sections and 10000 terminals are present at the same time, the calculation of the station range is ignored, and it is necessary to perform calculation for (200*10000) times under extreme conditions. This greatly improves the requirement on the calculation ability of the device and increases the purchase and maintenance costs of the device; meanwhile, a large amount of unnecessary data is calculated in the method, resulting in a great waste of the calculation ability of the device.

It may be understood that the above statement only provides a background technology related to the present invention, and does not necessarily constitute the prior art.

### SUMMARY

An objective of the present invention is to provide a positioning method capable of fusing a historical operation track and Beidou navigation, and an apparatus. According to the method, historical track information of a terminal is fully utilized for calculation, so that the calculation amount of a processor device is greatly reduced, and the compression rate can reach 98% or more; meanwhile, the calculation power can be greatly increased without adding a hardware device, and the input cost is very low. On the other hand, according to the method and the apparatus, the CPU utilization rate is increased; and a server with the same configuration can perform calculation tasks of larger stations, more stations and more terminals, so that the hardware input cost is saved.

To achieve the above objective, the present invention is implemented through the following technical solution:
a positioning method capable of fusing a historical operation track and Beidou navigation includes:
receiving longitude and latitude information sent by a Beidou navigation system;
determining the validity of historical track information in combination with the received longitude and latitude information and corresponding historical track information;
when the historical track information is valid, searching an alternative section according to types of a terminal, where the types of the terminal include a train and a handheld terminal;
the alternative section is traversed, and the longitude and latitude are converted to the section position information;
according to the types of the terminal, determining whether the converted section position information in the alternative section is valid; and when the converted section position information is valid, the section position information is output.

Optionally, the determining the validity of historical track information includes:
determining whether a time interval between the last update time of the longitude and latitude information of the corresponding terminal in the historical track information and the time corresponding to the current update of the longitude and latitude information is within a preset time range;
comparing the longitude and latitude information updated last time of the corresponding terminal in the historical track information with the longitude and latitude information currently updated, and determining whether position information corresponding to the longitude and latitude information currently updated is within a credible interval; and
when the time interval is within the preset time range and the position information corresponding to the longitude and latitude information currently updated is within the credible interval, considering that the historical track information is valid.

Optionally, when the terminal is the train, the alternative section is searched according to a search length of the train and a forward direction of the train.

Optionally, if a search range based on the search length spans a turnout, a section associated with turnout normal and reverse positions is also incorporated into the alternative section.

Optionally, the search length of train=a train speed*a time difference between previous update and current update+a redundant length.

Optionally, the redundant length is 1 meter.

Optionally, when the terminal is the handheld terminal, the alternative section is searched by taking the previous updated position of the handheld terminal as a circle center and taking a preset movement distance as a radius.

Optionally, the preset movement distance=a time difference between previous update and current update*a speed corresponding to a maximum human movement ability.

Optionally, the speed corresponding to maximum human movement ability is set to 10 m/s.

Optionally, when the historical track information is invalid, or the historical track information is valid but the converted section position information in the alternative section is invalid,
all stations are traversed, and the station where the longitude and latitude currently updated are located is searched;
all sections in the station are traversed, and all the sections are incorporated in the alternative section;
the alternative section is traversed, and the longitude and latitude are converted to the section position information;
whether the converted section position information in the alternative section is valid is determined; and
when the converted section position information is valid, the section position information is output.

Optionally, when the historical track information is valid but the converted section position information in the alternative section is invalid, and if the re-converted section position information is the same as the previous converted section position information, positioning is ended.

Optionally, the section position information includes an offset of a projection point of the terminal on a section on this section, and a distance from the terminal to this section.

Optionally, when the terminal is the train and if a distance from the train to the corresponding section is less than a preset error, section position information corresponding to this section is valid.

Optionally, the preset error is 1 meter.

Optionally, when the number of the valid section position information is greater than two, section position information corresponding to two sections with a minimum distance from the train is retained.

Optionally, when the terminal is the handheld terminal and if the number of the section position information is greater than zero, all converted section position information in the alternative section is valid.

Optionally, an early warning and protection apparatus includes a processor and a machine-readable storage medium, where the machine-readable storage medium stores machine-executable instructions executable by the processor, and the processor executes the machine-executable instructions to implement the above method.

Compared with the prior art, the present invention has the following advantages:

According to the positioning method capable of fusing the historical operation track and Beidou navigation, and the apparatus provided by the present invention, according to the method, historical track information of the terminal is fully utilized; when the historical track information is valid, calculation is performed based on the previous updated data, so that the calculation amount of the processor device is greatly reduced, and the compression rate can reach 98% or more; meanwhile, the calculation power can be greatly increased without adding a hardware device, and the input cost is very low. On the other hand, according to the method and the apparatus, the CPU utilization rate is increased; and a server with the same configuration can perform calculation tasks of larger stations, more stations and more terminals, so that the hardware input cost is saved.

### BRIEF DESCRIPTION OF THE DRAWINGS

FIG. 1 is a schematic diagram of a positioning method capable of fusing a historical operation track and Beidou navigation according to the present invention;

FIG. 2 is a schematic diagram of a train search alternative section according to the present invention;

FIG. 3 is a schematic diagram of another train search alternative section according to the present invention; and

FIG. 4 is a schematic diagram of a handheld terminal search alternative section according to the present invention.

### DETAILED DESCRIPTION OF THE EMBODIMENTS

A positioning method capable of fusing a historical operation track and Beidou navigation provided by the present invention will be further described below in detail with reference to the accompanying drawings and the specific embodiments. The advantages and features of the present invention will become clearer from the following description. It should be noted that the drawings are in a very simplified form and all use imprecise scales, which are only used to facilitate and clearly assist the objective of illustrating the embodiments of the present invention. To make the objectives, features and advantages of the present invention more comprehensible, please refer to the accompanying drawings.

It should be noted that terms “including”, “comprising” or any other variants thereof are intended to cover non-exclusive inclusion, so that a process, method, article or device including a series of elements includes not only those elements but also other elements not explicitly listed, or elements inherent to such a process, method, article, or device. Without further limitations, an element defined by the phrase “comprising a . . . ” does not exclude the presence of additional identical elements in the process, method, object or equipment including the element.

It should be noted that the device and method disclosed in the embodiments herein can also be implemented in other manners. The device embodiment described above is only exemplary. For example, the flowcharts and the block diagrams in the accompanying drawings show system architectures, functions and operation, which may be realized, of devices, methods and computer program products according to various embodiments of the specification. At this point, each block in the flowcharts or the block diagrams may represent one part of a module, program segment or code, where one of the module, program segment or code includes one or more executable instructions for realizing the specified logic functions; and one part of the module, program segment or code includes one or more executable instructions for implementing specified logical functions. It should be noted that, in some alternative embodiments, functions marked in the block may further occur in a different order than that marked in the accompanying drawings. For example, two continuous blocks actually may be executed in substantially parallel, and sometimes they may be executed in a reverse order, depending on the functions involved. It should also be noted that each block of the block diagrams and/or the flowcharts, and the combination of the blocks in the block diagrams and/or the flowcharts may be implemented by a dedicated hardware-based system for performing the specified function or action, or may be implemented by the combination of the dedicated hardware and computer instructions.

Further, “the steps 1, 2, 3 . . . ” mentioned in the present invention are only for distinguishing each operation step, and the size relationship between the numbers behind the steps does not represent the order of the operation steps.

In practical application, train positioning calculation of an early warning and protection system in the field of rail traffic is implemented based on longitude and latitude information provided by a Beidou navigation system. The Beidou navigation system may provide real-time longitude and latitude information of a train or handheld terminal to the early warning and protection system at fixed time intervals, or may trigger the Beidou navigation system to update the longitude and latitude information at variable time intervals or based on some instructions, which is not limited by the present invention.

Based on the problems mentioned in the background technology, the present invention provides a positioning method capable of fusing a historical operation track and Beidou navigation. The method includes: receiving longitude and latitude information sent by a Beidou navigation system; determining validity of historical track information in combination with received longitude and latitude information and corresponding historical track information; when the historical track information is valid, searching an alternative section according to types of a terminal, where the types of the terminal include a train and a handheld terminal; traversing the alternative section, and converting longitude and latitude to section position information; according to the types of the terminal, determining whether converted section position information in the alternative section is valid; and when the converted section position information is valid, outputting the section position information.

In practical application, the longitude and latitude information for positioning the terminal by the Beidou navigation system will carry an entity ID of the terminal, the specific type of the terminal can be determined according to the ID, and the historical track information corresponding to the terminal can also be found accordingly.

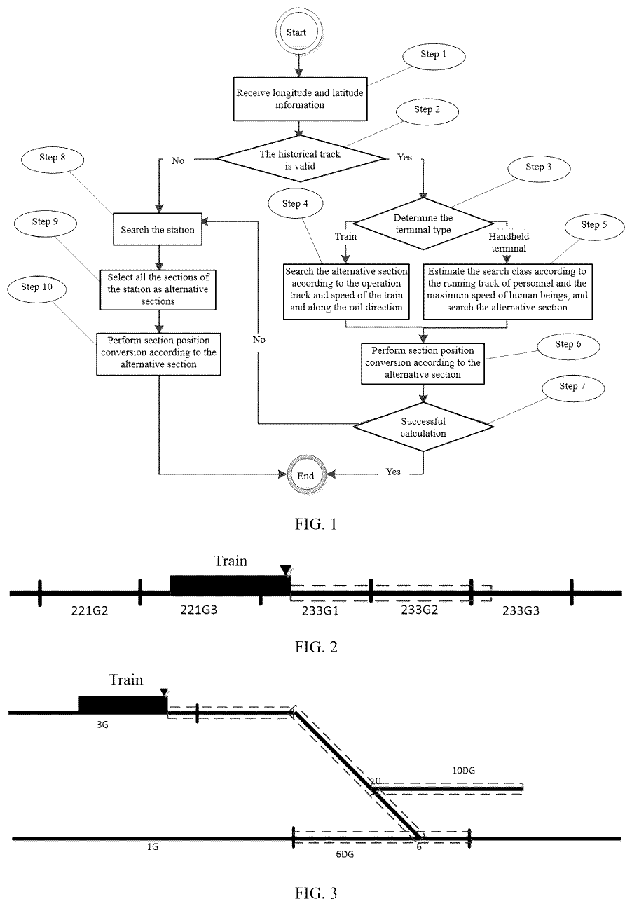

The positioning method capable of fusing a historical operation track and Beidou navigation according to the present invention is further described below with reference to FIG. 1. The method includes:

Step 1: an early warning and protection system receives longitude and latitude information of a terminal sent by a Beidou navigation system.

Step 2: the early warning and protection system determines the validity of historical track information in combination with the received longitude and latitude information and the corresponding historical track information, that is, in combination with the longitude and latitude information currently updated and the corresponding historical track information.

The step of determining the validity of the historical track information includes: it is determined whether a time interval between the last update time of the longitude and latitude information of the corresponding terminal in the historical track information and the time corresponding to the current update of the longitude and latitude information is within a preset time range; the longitude and latitude information updated last time of the corresponding terminal in the historical track information is compared with the longitude and latitude information currently updated, and is converted into space information; and it is determined whether position information corresponding to the longitude and latitude information currently updated is within a credible interval. When the time interval is within the preset time range and the position information corresponding to the longitude and latitude information currently updated is within the credible interval, the historical track information is considered to be valid.

Step 3: when the historical track information is valid, an alternative section is searched according to types of the terminal. Different search strategies are adopted according to different device types. The section number and the section name of the alternative section can be determined according to the search result. In this embodiment, the types of the terminal include a train and a handheld terminal.

Step 4: when the terminal is the train, the alternative section is searched according to a search length of the train and a forward direction of the train.

The train operates on the rail necessarily, so a distance (the search length of the train) is searched forward along the forward direction of the train and in combination with the historical track of the train and the train speed, and all sections in the distance are incorporated into the alternative section. Further, if a search range based on the search length spans a turnout, a section associated with turnout normal and reverse positions is also incorporated into the alternative section.

In this embodiment, the search length of train=a train speed*a time difference between previous update and current update+a redundant length. The redundant length can further incorporate possible operation sections of the train into the search range, thereby further ensuring the positioning accuracy of the positioning method according to the present invention. Optionally, the redundant length is 1 meter. Of course, the redundant length may also be other values, which can be set according to requirements in practical application and will not be limited by the present invention.

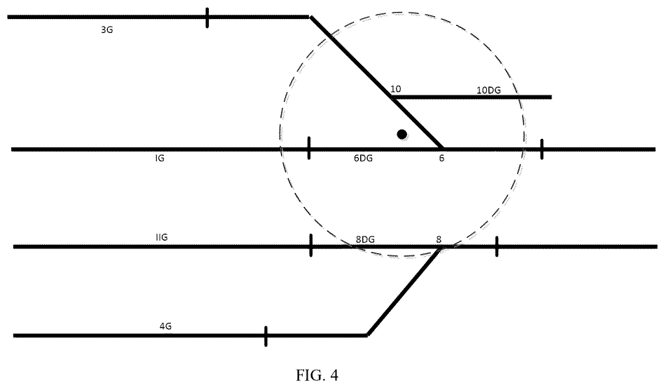

For example, as shown in FIG. 2, the head of the train is at the section 233G1, the search length of the train is calculated according to the train speed and the time difference with the previous cycle, and forward search is performed according to the search length (the dotted line range is the search length) to obtain the alternative section including three sections 233G1, 233G2 and 233G3. As shown in FIG. 3, in another example, the head of the train is at the section 3G, the search length is calculated according to the train speed and the time difference from the previous cycle, forward search is performed according to the search length (the dotted line range is the search length), and since the search length spans the turnout, the alternative section including three sections of 3G, No. 10 turnout and No. 6 turnout is obtained.

Step 5: when the terminal is the handheld terminal, the handheld terminal is generally carried by a worker, so the handheld terminal is considered to represent the worker. Since the activity of the worker is random and irregular, the alternative section is searched by taking the previous updated position of the worker of the handheld terminal as a circle center and taking a preset movement distance as a radius.

In this embodiment, the nearby section is searched within the range by taking the updated position of the worker as the circle center and taking a preset movement distance estimated by the maximum human movement ability as a movement radius. The above search range has incorporated the possible displacement range of the worker into the search range as much as possible, so if the turnout section is searched during search, the section associated with the turnout normal and reverse positions will not be incorporated into the alternative section. The search can be based on the following data basis: station yard data read at the software initialization stage to calculate a distance between each section and the surrounding sections in advance according to the longitude and latitude.

In this embodiment, the preset movement distance=a time difference between previous update and current update*a speed corresponding to a maximum human movement ability. Optionally, the speed corresponding to the maximum human movement ability is set to 10 m/s, that is, assuming that the worker runs as hard as possible, there will be no problem of missing calculation according to the speed of 10 m/s.

For example, as shown in FIG. 4, a circular search range (the dotted line circle range in the figure) is calculated by taking the previous updated position of the worker (black point in the figure) as the circle center and taking the preset movement distance as the radius, and the alternative section including IG, No. 6 turnout, No. 10 turnout and No. 8 turnout is found according to the search range.

Step 6: the alternative section is traversed, and the longitude and latitude are converted to the section position information. Optionally, the converted section position information includes an offset of a projection point of the terminal on a section on this section (which position located in the section), and a distance between the terminal and this section (a distance from a point corresponding to the longitude and latitude to a straight line where the section is located, that is, a distance from a point to a straight line).

Step 7: it is determined whether the converted section position in the alternative section is valid. When the converted section position information is valid, calculation is successful, and the section position information is output. When there are a plurality of sections in the alternative section, that is, a plurality pieces of section position information is converted, the validity of each calculated section position information is respectively determined. After the calculation is successful and all effective section position information is output, calculation is ended.

Specifically, when the terminal is the train and if a distance from the train to the corresponding section is less than a preset error, section position information corresponding to this section is valid, otherwise, the section position information corresponding to this section is invalid. In this embodiment, the preset error is 1 meter. It may be understood that the preset error is not limited to the above, and can be set to other values according to the actual requirements, which will not be limited by the present invention. Further, when the number of the valid section position information is greater than two, section position information corresponding to two sections with a minimum distance from the train is retained, that is, two pieces of corresponding section position information with the minimum distance between the train and the section are retained, and the calculation result with the large distance is discarded, so that the positioning accuracy of the method is improved.

When the terminal is the handheld terminal and if the number of the section position information is greater than zero, all converted section position information in the alternative section is valid. That is, when the terminal is the handheld terminal, the number of the section position information is only required to be greater than 0, because human activities are irregular and will occur in a plurality of sections, so that there will be relative position information on the plurality of sections.

As shown in FIG. 1, in the step 2, when it is determined that the historical track information is invalid, or in the step 7, the historical track information is valid and the converted section position information in the alternative section is invalid, the method further includes: step 8: all stations are traversed, and the station where the longitude and latitude currently updated are located or corresponding to the longitude and latitude currently updated is searched. Step 9: all sections in the station are traversed, and all the sections are incorporated in the alternative section. Step 10: the alternative section is traversed, and the longitude and latitude are converted to the section position information; it is determined whether the converted section position information in the alternative section is valid; and when the converted section position information is valid, the section position information is output. The validity determination here can be performed with reference to the above validity determination method. That is, for a vehicle, it is necessary to eliminate unreasonable section information, mainly including the section information with the section distance outside the error range(calculated based on 1 m at present); and for the handheld terminal, it is not necessary to perform validity determination.

Optionally, when the historical track information is valid but the converted section position information in the alternative section is invalid, and if the re-converted section position information is the same as the previous converted section position information, that is, consistent with the converted content in the step 6, since the possibility of the validity is not further calculated and determined, this calculation is ended.

Based on the same inventive concept, the present invention further provides an early warning and protection apparatus. The early warning and protection apparatus includes a processor and a machine-readable storage medium, where the machine-readable storage medium stores machine-executable instructions executable by the processor, and the processor executes the machine-executable instructions to implement the above positioning method. Optionally, the early warning and protection system includes the early warning and protection apparatus, or is the early warning and protection apparatus.

Based on the above, according to the positioning method capable of fusing the historical operation track and Beidou navigation provided by the present invention, calculation is performed by the historical operation track data of the terminal, the section where the terminal is located can be calculated roughly, two sections will be calculated generally, 3 to 4 sections may be calculated in particular cases, and then calculation is performed based on the calculated sections, so that the section position of the terminal is calculated. According to the positioning calculation method, calculation is performed according to the scale of 30 stations, 200 sections in each station and 10000 terminals, the calculation of the station range is ignored, and in extreme cases, only (4*10000) calculations are required, which is one fiftieth of the original calculation amount, so that the calculation amount is greatly reduced; and the more the sections of the station, the more significant the optimization effect. Further, the positioning method of the present invention has been tested by the actual early warning and protection system, the calculation amount can be greatly compressed, especially for the complex station yard, the compression rate is very considerable, and the calculation power is greatly saved, so that the hardware input cost is solved.

In conclusion, in the positioning method capable of fusing the historical operation track and Beidou navigation, and the apparatus, provided by the present invention, according to the method, the historical track information of the terminal is fully utilized for calculation, so that the calculation amount of a processor device is greatly reduced, and the compression rate can reach 98% or more; meanwhile, the calculation power can be greatly increased without adding a hardware device, and the input cost is very low. On the other hand, according to the method and the apparatus, the CPU utilization rate is increased; and a server with the same configuration can perform calculation tasks of larger stations, more stations and more terminals, so that the hardware input cost is saved.

Although the content of the present invention has been described in detail through the aforementioned preferred embodiments, it should be recognized that the above description should not be considered as limiting the present invention. Various modifications and alternatives to the present invention will become apparent to those skilled in the art upon reading the foregoing disclosure. Accordingly, the protection scope of the present invention shall be limited by the appended claims.

1. A positioning method capable of fusing a historical operation track and Beidou navigation, comprising:
receiving longitude and latitude information sent by a Beidou navigation system;
determining validity of historical track information in combination with received longitude and latitude information and corresponding historical track information;
when the historical track information is valid, searching an alternative section according to types of a terminal, where the types of the terminal comprise a train and a handheld terminal;
traversing the alternative section, and converting longitude and latitude to section position information;
according to the types of the terminal, determining whether converted section position information in the alternative section is valid; and
when the converted section position information is valid, outputting the section position information.

2. The positioning method capable of fusing a historical operation track and Beidou navigation according to claim 1, wherein the determining validity of historical track information comprises:
determining whether a time interval between last update time of longitude and latitude information of a corresponding terminal in the historical track information and time corresponding to a current update of the longitude and latitude information is within a preset time range;
comparing the longitude and latitude information updated last time of the corresponding terminal in the historical track information with the longitude and latitude information currently updated, and
determining whether position information corresponding to the longitude and latitude information currently updated is within a credible interval; and
when the time interval is within the preset time range and the position information corresponding to the longitude and latitude information currently updated is within the credible interval, considering that the historical track information is valid.

3. The positioning method capable of fusing a historical operation track and Beidou navigation according to claim 1, wherein
when the terminal is the train, the alternative section is searched according to a search length of the train and a forward direction of the train.

4. The positioning method capable of fusing a historical operation track and Beidou navigation according to claim 3, wherein
if a search range based on the search length spans a turnout, a section associated with turnout normal and reverse positions is also incorporated into the alternative section.

5. The positioning method capable of fusing a historical operation track and Beidou navigation according to claim 3, wherein
the search length of the train=a train speed*a time difference between previous update and current update+a redundant length.

6. The positioning method capable of fusing a historical operation track and Beidou navigation according to claim 5, wherein
the redundant length is 1 meter.

7. The positioning method capable of fusing a historical operation track and Beidou navigation according to claim 1, wherein
when the terminal is the handheld terminal, the alternative section is searched by taking a previous updated position of the handheld terminal as a circle center and taking a preset movement distance as a radius.

8. The positioning method capable of fusing a historical operation track and Beidou navigation according to claim 7, wherein
the preset movement distance=a time difference between previous update and current update*a speed corresponding to maximum human movement ability.

9. The positioning method capable of fusing a historical operation track and Beidou navigation according to claim 8, wherein
the speed corresponding to maximum human movement ability is set to 10 m/s.

10. The positioning method capable of fusing a historical operation track and Beidou navigation according to claim 1, wherein
when the historical track information is invalid, or the historical track information is valid but the converted section position information in the alternative section is invalid,
all stations are traversed, and a station where the longitude and latitude currently updated are located is searched;
all sections in the station are traversed, and all the sections are incorporated in the alternative section;
the alternative section is traversed, and the longitude and latitude are converted to the section position information;
whether the converted section position information in the alternative section is valid is determined; and
when the converted section position information is valid, the section position information is output.

11. The positioning method capable of fusing a historical operation track and Beidou navigation according to claim 10, wherein
when the historical track information is valid but the converted section position information in the alternative section is invalid, and if the re-converted section position information is the same as the previous converted section position information, positioning is ended.

12. The positioning method capable of fusing a historical operation track and Beidou navigation according to claim 1, wherein
the section position information comprises an offset of a projection point of the terminal on a section on this section, and a distance from the terminal to this section.

13. The positioning method capable of fusing a historical operation track and Beidou navigation according to claim 12, wherein
when the terminal is the train and if a distance from the train to a corresponding section is less than a preset error, section position information corresponding to this section is valid.

14. The positioning method capable of fusing a historical operation track and Beidou navigation according to claim 13, wherein
the preset error is 1 meter.

15. The positioning method capable of fusing a historical operation track and Beidou navigation according to claim 13, wherein
when the number of the valid section position information is greater than two, section position information corresponding to two sections with a minimum distance from the train is retained.

16. The positioning method capable of fusing a historical operation track and Beidou navigation according to claim 1, wherein
when the terminal is the handheld terminal and if the number of the section position information is greater than zero, all converted section position information in the alternative section is valid.

17. An early warning and protection apparatus, comprising a processor and a machine-readable storage medium, wherein the machine-readable storage medium stores machine-executable instructions executable by the processor, and the processor executes the machine-executable instructions to implement the method according to claim 1.
